(19) United States
(12) Patent Application Publication
(10) Pub. No.: US 2023/0320440 A1
(43) Pub. Date: Oct. 12, 2023

(54) SEALING STRIP, RESPIRATOR, AND METHOD FOR MANUFACTURING SEALING STRIP

(71) Applicant: 3M INNOVATIVE PROPERTIES COMPANY, St. Paul, MN (US)

(72) Inventors: Hui Juan Chen, Shanghai (CN); Thomas J. Xue, Woodbury, MN (US); You San Qian, Shanghai (CN); Xujun Yu, Shanghai (CN); Zhigang Yu, Shanghai (CN)

(21) Appl. No.: 18/041,888

(22) PCT Filed: Aug. 16, 2021
(86) PCT No.: PCT/IB2021/057525

§ 371 Date: Feb. 16, 2023

(30) Foreign Application Priority Data
Aug. 17, 2020 (CN) 202010825606.4

(51) Int. Cl. A41D 13/11; B26D 7/34; B26D 3/10

(52) U.S. Cl. CPC A41D 13/1138; B26D 7/34; B26D 3/10

(57) ABSTRACT

The present invention relates to a sealing strip, a respirator, and a method for manufacturing a sealing strip. The sealing strip includes a main body part, the main body part having an upper surface, a lower surface, a first side surface, and a second side surface opposite to the first side surface. The main body part includes a curved surface part. The curved surface part includes a first convex part and a second convex part, and the first convex part and the second convex part are connected to each other in the lengthwise direction of the sealing strip to define a concave part located therebetween. The concave part is configured to accommodate the nose of a wearer. The first convex part and the second convex part are symmetrical about the concave part. A first side surface of the curved surface part is a sinusoidal curved surface with a constant amplitude extending in the lengthwise direction of the sealing strip. By the sealing strip, the respirator and the method for manufacturing a sealing strip according to the present invention, a manufacturing process of the sealing strip can be simplified; a maximum utilization rate of materials can be achieved; sealing between the respirator and the face of the wearer can be improved, and the wearing comfort of the respirator can be increased.

### TECHNICAL FIELD

The present invention relates to the field of personal protection, and in particular, to a sealing strip, a respirator provided with the sealing strip, and a method for manufacturing a sealing strip.

### BACKGROUND

The content of this part provides only background information related to the present invention, and does not necessarily constitute the prior art.

As a commonly used protective article, a respirator is often used to protect against dust, mist, bacteria, etc., and is widely used in specific working environments and daily life. Ideally, when a respirator is worn, the respirator can fit the contour of the face of a wearer to form good sealing between the respirator and the face of the wearer. However, the contour of the face of the wearer is not a regular contour, and wearers have large individual differences. Especially, the contour of the nose is complex and fluctuates; it is often difficult to form good sealing with the respirator, and a gap is often present between the respirator and the nose area of the wearer, resulting in a poor sealing effect. As a result, in the one hand, dust, mist or bacteria in an environment where the wearer is located will be in contact with the wearer through the gap and is inhaled by the wearer, thus affecting the protective effect of the respirator. On the other hand, the exhaled breath of the wearer will also be discharged upwards through this gap. For the case where the wearer wears glasses, if the temperature in the respirator is higher than the ambient temperature, the exhaled breath will cause fogging on the glasses and affect the wearing experience of the wearer.

Therefore, in order to improve the protective effect of the respirator and improve the wearing experience, it is expected that the respirator can fit the contour of the face of the wearer and achieve good sealing between the respirator and the face of the wearer. In an existing respirator, a metal or plastic nose strip with a memory effect is used. When this type of respirator is worn, by applying a pressure to this part of the respirator, the nose strip of the respirator is deformed to fit the contour of the nose of the wearer, so that the respirator is pressed against and fits the face of the wearer, thus improving the sealing between the respirator and the nose of the wearer. However, the pressure applied to the nose of the wearer by the nose strip of such a respirator is prone to cause discomfort to the wearer, and it is easy to cause indentation and even cause trauma on the face of the wearer. The situation is particularly obvious when the respirator is worn for a long time.

Therefore, it is desired to improve the wearing comfort and sealing performance of the respirator.

### SUMMARY

An objective of the present invention is to provide an improved sealing strip and a respirator provided with the sealing strip, so as to improve the wearing comfort of the respirator, improve the sealing performance of the sealing strip, and improve the sealing between the respirator and the face of a wearer. Another objective of the present invention is to provide a method for manufacturing a sealing strip as well as a sealing strip manufactured thereby and a respirator, so as to simplify the manufacturing of the sealing strip, improve the wearing comfort of the respirator, improve the sealing performance between the respirator and the face of the wearer, alleviate the fogging problem of the glasses of the wearer, and improve the utilization rate of raw materials of the sealing strip.

One aspect of the present invention is to provide a sealing strip for a respirator. The sealing strip comprises a main body part, and the main body part has an upper surface, a lower surface, a first side surface, and a second side surface opposite to the first side surface. The second side surface is to be attached to a respirator main body of the respirator so that the first side surface faces a wearer, and the sealing strip covers at least a part of a peripheral edge of the respirator main body to be in contact with the face of the wearer. The main body part comprises a curved surface part; the curved surface part comprises a first convex part and a second convex part; the first convex part and the second convex part are connected to each other in the lengthwise direction of the sealing strip to define a concave part located between the first convex part and the second convex part. The concave part is configured to accommodate the nose of the wearer; the first convex part and the second convex part are symmetrical about the concave part, and a first side surface of the curved surface part is a sinusoidal curved surface with a constant amplitude extending in the lengthwise direction of the sealing strip. Preferably, the curved surface part is formed integrally.

The distance between the first side surface and a second side surface of the curved surface part is the thickness of the curved surface part, and the smallest thickness of the curved surface part at two ends in the lengthwise direction of the sealing strip is equal to the smallest thickness of the curved surface part at the concave part.

In one embodiment, the main body part further comprises a first extension part and a second extension part respectively located on two sides of the curved surface part in the lengthwise direction of the sealing strip; the first extension part extends from the first convex part to a first end of the sealing strip; the second extension part extends from the second convex part to a second end of the sealing strip. The distance between a first side surface and a second side surface of the first extension part and/or the second extension part is constant or variable.

In one embodiment, the first extension part and the second extension part have the same contour.

The first extension part, the curved surface part, and the second extension part are formed integrally. Alternatively, the first extension part, the curved surface part, and the second extension part are formed separately and attached to each other.

In one embodiment, the first extension part, the curved surface part, and the second extension part collectively cover the entire peripheral edge of the respirator main body to be in contact with the face of the wearer.

Preferably, the distance between an upper surface and a lower surface of the curved surface part is 6 mm to 14 mm. Preferably, the length of the curved surface part in the lengthwise direction of the sealing strip is 90 mm to 130 mm. Preferably, at the concave part, the smallest distance between the first side surface and the second side surface of the curved surface part is 1 mm to 6 mm. Preferably, the greatest distance between a first side surface and a second side surface of the first convex part and the second convex part is greater than the smallest distance between the first side surface and the second side surface of the curved surface part by 4 mm to 10 mm.

In one embodiment, the sealing strip further comprises an air-proof layer and an anchor layer; the air-proof layer is anchored on one of the upper surface and the lower surface of the main body part through the anchor layer, and when the sealing strip is attached to the respirator, the air-proof layer of the sealing strip is located on a peripheral side.

Another aspect of the present invention is to provide a respirator, the respirator comprising a respirator main body. The respirator further comprises the sealing strip for the respirator according to the present invention, and the sealing strip is attached to the respirator main body to cover at least a part of a peripheral edge of the respirator main body to be in contact with the face of a wearer.

Still another aspect of the present invention is to provide a method for manufacturing a sealing strip, the method comprising: providing a first material piece; and cutting the first material piece to prepare a main body part of the sealing strip, the main body part having an upper surface, a lower surface, a first side surface, and a second side surface opposite to the first side surface. The second side surface is to be attached to a respirator main body of a respirator so that the first side surface faces a wearer, and the sealing strip covers at least a part of a peripheral edge of the respirator main body to be in contact with the face of the wearer. The main body part is cut to have a curved surface part; the curved surface part comprises a first convex part and a second convex part; the first convex part and the second convex part are connected to each other in the lengthwise direction of the sealing strip to define a concave part located between the first convex part and the second convex part; the concave part is configured to accommodate the nose of the wearer; the first convex part and the second convex part are symmetrical about the concave part, and a first side surface of the curved surface part is a sinusoidal curved surface with a constant amplitude extending in the lengthwise direction of the sealing strip. Preferably, the curved surface part is formed integrally.

The step of cutting the first material piece comprises: cutting the first material piece along a first cutting line, a second cutting line, and a third cutting line respectively to form a first strip and a second strip fitted to each other along the second cutting line. The first cutting line and the third cutting line are straight lines parallel to each other; the second cutting line is located between the first cutting line and the third cutting line, and the second cutting line comprises one or a plurality of sinusoidal curve segments, so that the first strip and the second strip each comprise at least one curved surface segment having the same contour as the curved surface part. The step of cutting the first material piece further comprises cutting the first strip and the second strip to form the sealing strip comprising the curved surface part.

In one embodiment, the distance between the first side surface and a second side surface of the curved surface part is the thickness of the curved surface part, and the smallest thickness of the curved surface part at two ends in the lengthwise direction of the sealing strip is equal to the smallest thickness of the curved surface part at the concave part.

In one embodiment, the period of the sinusoidal curve segment is constant.

In one embodiment, the second cutting line further comprises another line segment alternating with the sinusoidal curve segment.

In one embodiment, the main body part further comprises a first extension part and a second extension part respectively located on two sides of the curved surface part in the lengthwise direction of the sealing strip, and the step of cutting the first material piece further comprises: cutting the main body part out from the first strip and the second strip respectively, so that the first extension part, the curved surface part, and the second extension part are formed integrally.

In one embodiment, the main body part further comprises a first extension part and a second extension part respectively located on two sides of the curved surface part in the lengthwise direction of the sealing strip, and the step of cutting the first material piece further comprises: cutting the curved surface segment out from the first strip and the second strip to form the curved surface part of the main body part; and cutting the first material piece to form one or a plurality of first extension parts and one or a plurality of second extension parts. The method for manufacturing the sealing strip further comprises: attaching the first extension part and the second extension part to the two sides of the curved surface part respectively before or after the curved surface part is attached to the respirator main body.

In one embodiment, the method for manufacturing the sealing strip further comprises: before cutting the first material piece, providing an air-proof layer and an anchor layer on the first material piece so that the sealing strip further comprises the air-proof layer anchored on one of the upper surface and the lower surface of the main body part through the anchor layer.

The air-proof layer is formed on the first material piece in one of the following manners: attaching an incompletely cured air-proof film to one side surface of the first material piece and curing the same to form the air-proof layer integrally with the first material piece; and spraying an anchor layer material on one side surface of the first material piece and/or one side surface of an air-proof member, and fitting the air-proof member to the first material piece through the anchor layer material, wherein the anchor layer material is cured to form the anchor layer, and the air-proof member is anchored on the first material piece through the anchor layer to form the air-proof layer.

Still another aspect of the present invention is to provide a sealing strip, and the sealing strip is manufactured by using the method for manufacturing the sealing strip according to the present invention.

Yet another aspect of the present invention is to provide a respirator; the respirator comprises a respirator main body, and the respirator further comprises the sealing strip manufactured by using the method for manufacturing the sealing strip according to the present invention.

An improved sealing strip, a respirator, and a method for manufacturing a sealing strip are provided in the present invention. By the sealing strip, the respirator, and the method for manufacturing a sealing strip according to the present invention, the manufacturing of the sealing strip can be simplified; the manufacturing quality of the sealing strip can be improved; the maximum utilization rate of the material can be achieved; the sealing between the respirator and the face of the wearer can be improved; the wearing comfort of the respirator can be improved.

### BRIEF DESCRIPTION OF THE DRAWINGS

The embodiments of the present invention are described below merely as examples with reference to the accompanying drawings. In the accompanying drawings, the same features or components are represented by the same reference numerals, and the accompanying drawings are not necessarily drawn to scale. Further, in the accompanying drawings:

FIG. 1 is a perspective view of a sealing strip according to a first embodiment of the present invention;

FIG. 2 is a schematic view of cutting the sealing strip in FIG. 1;

FIG. 3 is a top view of the sealing strip in FIG. 1;

FIG. 4 is a front view of the sealing strip in FIG. 1;

FIG. 5 is a side view of a first respirator provided with the sealing strip according to the first embodiment of the present invention;

FIG. 6 is a perspective view of the first respirator in FIG. 5, where the sealing strip of the first respirator is shown;

FIG. 7 is a front view of a second respirator provided with the sealing strip according to the first embodiment of the present invention;

FIG. 8 is a perspective view of the second respirator in FIG. 7, where the sealing strip of the second respirator is shown;

FIG. 9 is a perspective view of a sealing strip according to a second embodiment of the present invention;

FIG. 10 is a top view of the sealing strip in FIG. 9;

FIG. 11 is a front view of the sealing strip in FIG. 9;

FIG. 12 is a schematic view of a third respirator provided with the sealing strip according to the second embodiment of the present invention;

FIG. 13 is another schematic view of the third respirator in FIG. 12, where the sealing strip of the third respirator is shown; and

FIG. 14 is a schematic view of a fourth respirator provided with the sealing strip according to the second embodiment of the present invention.

### DETAILED DESCRIPTION

The following descriptions are substantially merely exemplary, and are not intended to limit the present invention, the application, and the use. It should be understood that in all of the accompanying drawings, similar reference numerals represent the same or similar parts and features. The accompanying drawings illustratively show the idea and principles of the embodiments of the present invention, but do not necessarily show specific size of each embodiment of the present invention and the scale thereof. In some parts of specific accompanying drawings, related details or structures of the embodiments of the present invention may be illustrated in an exaggerated manner.

In the description of the embodiments of the present invention, related directional terms such as “upper,” “lower,” “left,” and “right” are used for description in upper, lower, left, and right positions in the views shown in the accompanying drawings. In practical applications, the positional relationships of “upper,” “lower,” “left,” and “right” used herein may be defined according to actual situations, and these relationships can be reversed.

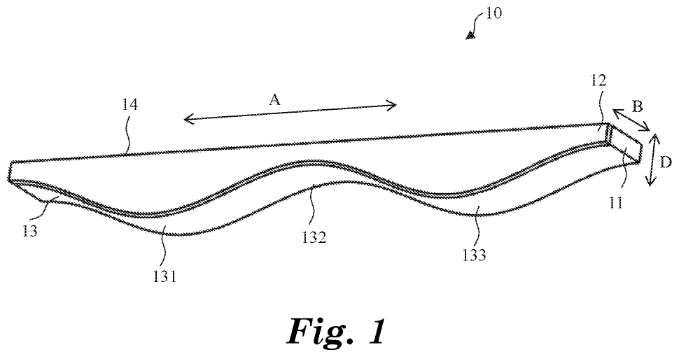

FIG. 1 is a perspective view of a sealing strip 10 according to a first embodiment of the present invention. As shown in FIG. 1, the sealing strip 10 has an integrated structure, including a flexible main body part 11 and an air-proof layer 12. The main body part 11 is made of a flexible porous material, for example, foam. The foam may be, for example, polyurethane, polyvinyl chloride, polypropylene, polyethylene, polyethylene vinyl acetate, rubber, or a combination thereof. The air-proof layer 12 is provided on an upper surface or a lower surface of the main body part 11 in the height direction (the direction indicated by a double-headed arrow B in FIG. 1). In FIG. 1, the air-proof layer 12 is provided on the upper surface of the main body part 11. The air-proof layer 12 is formed on the main body part 11 before the sealing strip 10 is cut and formed. For example, before the sealing strip 10 is formed, an air-proof layer may be formed on one side surface of the foam used for manufacturing the main body part 11 of the sealing strip 10, and the air-proof layer is formed integrally with the foam. The thickness (the size in the height direction of the main body part 11) of the air-proof layer formed on the foam may be set according to an application requirement of the sealing strip 10. The air-proof layer and an anchor layer may be provided on a material piece (for example, foam) used for manufacturing the main body part 11 so that the air-proof layer is anchored, through the anchor layer, on the material piece used for manufacturing the main body part 11. The material of the anchor layer may be the same as or different from the material of the air-proof layer. For example, an incompletely cured air-proof film may be attached to one side surface of the foam and cured to form the air-proof layer and the anchor layer integrally with the foam. The air-proof film may be, for example, a polyurethane film. Alternatively, an anchor layer material may be sprayed on one side surface of an air-proof member and/or the foam so that the air-proof member is fit to the foam through the anchor layer material. The anchor layer material is cured to form the anchor layer, and the air-proof member is anchored on the foam through the anchor layer to form the air-proof layer.

The sealing strip 10 has a first side surface 13 extending in the lengthwise direction of the sealing strip 10 (the direction indicated by a double-headed arrow A in FIG. 1) and a second side surface 14 opposite to the first side surface 13. The direction indicated by a double-headed arrow D in FIG. 1 is the thickness direction of the sealing strip 10, and the distance between the first side surface 13 and the second side surface 14 is the thickness of the sealing strip 10. The main body part 11 of the sealing strip 10 is formed as a curved surface part, and preferably, the main body part 11 is integrally formed as the curved surface part, including a first convex part 131 and a second convex part 133. The first convex part 131 and the second convex part 133 are connected to each other in the lengthwise direction of the sealing strip 10, and define a concave part 132 located between the first convex part 131 and the second convex part 133. The first convex part 131 and the second convex part 132 are symmetrical to each other about the concave part 132; the smallest thickness portion of the main body part 11 at the concave part 132 is located at an intermediate position in the lengthwise direction of the main body part 11, and a first side surface of the curved surface part (that is, the first side surface 13 of the sealing strip 10) is a curved surface having a sinusoidal contour with a constant amplitude in the lengthwise direction of the sealing strip 10. A second side surface of the curved surface part (that is, the second side surface 14 of the sealing strip 10) is a substantially flat surface to facilitate attachment of the sealing strip 10 to a target product. The target product may be, for example, a respirator. The sealing strip 10 may be used as a nose strip of various respirators, and the respirator may be, for example, a mask. When the sealing strip 10 is attached to the respirator, the second side surface 14 is attached to a respirator main body of the respirator; the first side surface 13 faces a wearer; the air-proof layer 12 is located on the upper side; the concave part 132 is configured to accommodate the nose of the wearer. For example, adhesive is sprayed on or applied to a position on the respirator main body where the sealing strip 10 is to be installed and/or the second side surface 14 of the sealing strip 10, so as to attach the second side surface 14 of the sealing strip 10 to the respirator main body.

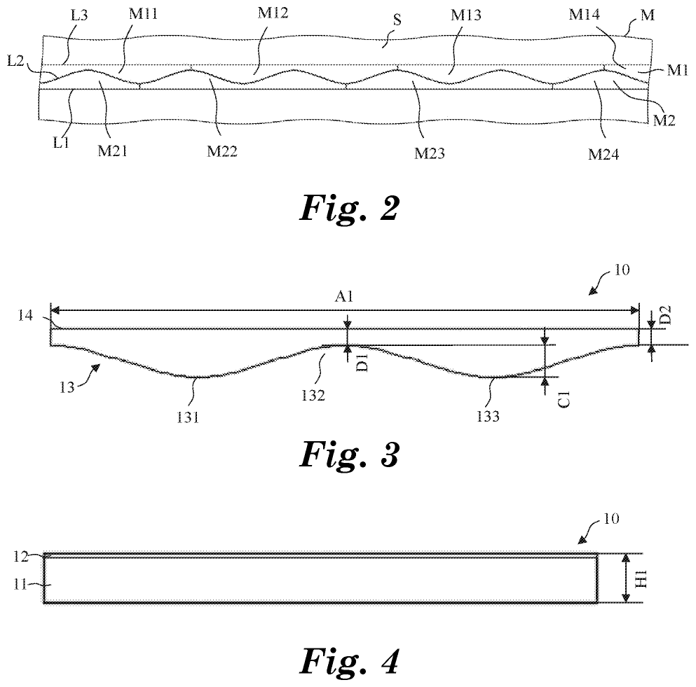

The sealing strip 10 is configured to have the contour as described above, so that the maximum utilization rate of materials for manufacturing the sealing strip 10 can be achieved while making the sealing strip 10 fit the nose of the wearer to meet ergonomics. FIG. 2 is a schematic view of preparing the sealing strip 10 using a first material piece M. For example, the first material piece M may be foam. As shown in FIG. 2, an air-proof layer S is formed on one side surface of the first material piece M, and then, in a direction substantially perpendicular to the air-proof layer S (i.e., the direction perpendicular to the paper surface in FIG. 2), the first material piece M provided with the air-proof layer S is cut along a first cutting line L1, a second cutting line L2, and a third cutting line L3 respectively. The first cutting line L1 and the third cutting line L3 are straight lines substantially parallel to each other. The second cutting line L2 is located between the first cutting line L1 and the third cutting line L3 and is a sinusoidal curve. The sinusoidal curve has the same amplitude and period as the sinusoidal contour of the first side surface 13 of the sealing strip 10 in the lengthwise direction of the sealing strip. The first material piece M is cut along the first cutting line L1, the second cutting line L2, and the third cutting line L3 to obtain a first strip M1 and a second strip M2 that are fitted to each other along the second cutting line L2. The first strip M1 and the second strip M2 are complementary in shape, and each include a plurality of curved surface segments connected to each other in the extending direction of the first cutting line L1, the second cutting line L2, and the third cutting line L3. Each curved surface segment has the same contour as the sealing strip 10. As schematically shown in FIG. 2, the first strip M1 includes a first curved surface segment M11, a second curved surface segment M12, a third curved surface segment M13, and a fourth curved surface segment M14, and the second strip M2 includes a first curved surface segment M21, a second curved surface segment M22, a third curved surface segment M23, and a fourth curved surface segment M24. The first curved surface segment M11 and the fourth curved surface segment M14 of the first strip M1 are not completely shown, and the first curved surface segment M21 and the fourth curved surface segment M24 of the second strip M2 are also not completely shown. Then, the above curved surface segments are cut out from the first strip M1 and the second strip M2 to obtain a plurality of sealing strips 10. It should be noted here that the order of the above cutting steps is not necessary, and in other examples of the method for manufacturing a sealing strip according to the present invention, the above cutting steps may be interchanged or may be performed simultaneously. In the above preferred example, the second cutting line L2 is a continuous sinusoidal curve having the same amplitude and period as the sinusoidal contour of the first side surface 13 of the sealing strip 10 in the lengthwise direction of the sealing strip. Alternatively, the second cutting line L2 may be a curve in which sinusoidal curve segments alternate with other line segments. That is, a part of the second cutting line L2 is sinusoidal curve segments of which the amplitude and period are the same as the amplitude and axis of the sinusoidal contour of the first side surface of the sealing strip 10, and the remaining part of the second cutting line L2 is other line segments, for example, straight lines or other curves, alternating with the sinusoidal curve segments.

In the above example, the cutting process of the sealing strip is illustrated only by taking cutting the first strip M1 and the second strip M2 as an example. It should be noted here that during the actual cutting process of the sealing strip, the first material piece may be cut along a plurality of cutting lines at the same time to cut out a plurality of strips at the same time. For example, one or a plurality of sets of fourth cutting lines (not shown) and fifth cutting lines (not shown) may be provided alternately on the other side of the first cutting line L1, and one or a plurality of sets of sixth cutting lines (not shown) and seventh cutting lines (not shown) may be provided alternately on the other side of the third cutting line L3. The fourth cutting line and the sixth cutting line may be the same as the second cutting line L2, and the fifth cutting line and the seventh cutting line may be the same as the first cutting line L1 or the third cutting line L3. The first material piece may be cut along all cutting lines at the same time to cut out a plurality of strips at the same time.

FIG. 3 and FIG. 4 show preferred size parameters of the sealing strip 10. FIG. 3 is a top view of the sealing strip 10 in FIG. 1, and FIG. 4 is a side view of the sealing strip 10 observed from one side where the first side surface 13 is located. Preferably, the length A1 of the sealing strip 10 may be set in a range of 90 mm to 130 mm, and the smallest thickness D1 of the curved surface part of the sealing strip 10 at the concave part 132 (i.e., the smallest distance between the first side surface 13 and the second side surface 14) may be set in a range of 1 mm to 6 mm. More preferably, the smallest thickness D1 may be set in a range of 2 mm to 5 mm. Particularly preferably, the smallest thickness D1 of the curved surface part of the sealing strip 10 at the concave part 132 is equal to the smallest thickness D2 of the curved surface part of the sealing strip 10 at two ends in the lengthwise direction. Preferably, the greatest distance C1 by which the first convex part 131 and the second convex part 133 protrude from the smallest thickness position of the concave part 132 is set to 4 mm to 10 mm. Preferably, the height H1 of the sealing strip 10 (i.e., the distance between the upper surface and the lower surface of the sealing strip 10) is set in a range of 6 mm to 14 mm. In a preferred example, the length A1 of the sealing strip 10 is 110 mm; the smallest thickness D1 is 3 mm; the distance C1 is 6 mm; the height H1 is 10 mm; the height of the air-proof layer 12 (the size in the direction shown by an arrow B in FIG. 1, that is, the size in the same direction as the height H1) is 10 μm to 100 μm.

Since the sealing strip 10 has the above sinusoidal contour, the first strip M1 and the second strip M2 are complementary in shape. Especially, in a configuration where the smallest thickness D1 of the curved surface part of the sealing strip 10 at the concave part 132 is equal to the smallest thickness D2 of the curved surface part of the sealing strip 10 at the two ends in the lengthwise direction, the first material piece M may be used to the maximum extent to prepare the sealing strip 10, thus achieving the maximum utilization rate of materials. In addition, since the air-proof layer 12 of the sealing strip 10 is formed on one side surface of the first material piece M before the first material piece M is cut, the air-proof layer 12 does not need to be separately provided when preparing each sealing strip 10. Therefore, the manufacturing of the sealing strip 10 is simplified, and the position deviation of the air-proof layer 12 of the sealing strip 10 due to the displacement of the air-proof layer when the first material piece M is cut can be prevented, thus helping to ensure the correct disposition of the air-proof layer 12 of the sealing strip 10.

In addition, by providing the above air-proof layer 12, the material for preparing the sealing strip 10 may be selected freely. For example, for 25% indentation generated, foam of which target pressure is in a range of 40 N to 500 N, preferably in a range of 60 N to 400 N, and more preferably in a range of 80 N to 350 N may be used to prepare the sealing strip 10. Different types of foam samples with different parameters that can be used for preparing the sealing strip 10 are listed in Table 1 shown below. By forming an air-proof layer on sample 1 to sample 5 listed in Table 1, all the samples can be used to prepare the sealing strip 10 according to the present invention, and all of the above beneficial aspects of the sealing strip 10 can be achieved. It should be noted here that the foam samples listed in Table 1 are only exemplary, and other types of foam other than the samples listed in Table 1 may also be used for preparing the sealing strip 10.

TABLE 1
Foam samples and parameters thereof

| | Sample | Sample | Sample | Sample | Sample |
|---|---|---|---|---|---|
| | 1 | 2 | 3 | 4 | 5 |
| Weight (Kg/m³) | 30 | 30 | 26.5 | 30 | 32.5 |
| Pores per inch (PPI) | 60 | 75 | 50 | ≥45 | 60 |

Through the designs of the above structure, contour and size parameters of the sealing strip 10, the preparation of the sealing strip 10 can be simplified; the manufacturing quality of the sealing strip 10 can be ensured; the maximum utilization rate of materials can be achieved. Moreover, the restriction of the main material used for manufacturing the sealing strip 10 can be reduced, thus providing greater flexibility in the selection of materials.

The sealing strip 10 according to the first embodiment of the present invention may be used as a nose strip of a respirator, and may be applied to various respirators, for example, various earloop respirators, head-mounted respirators, etc.

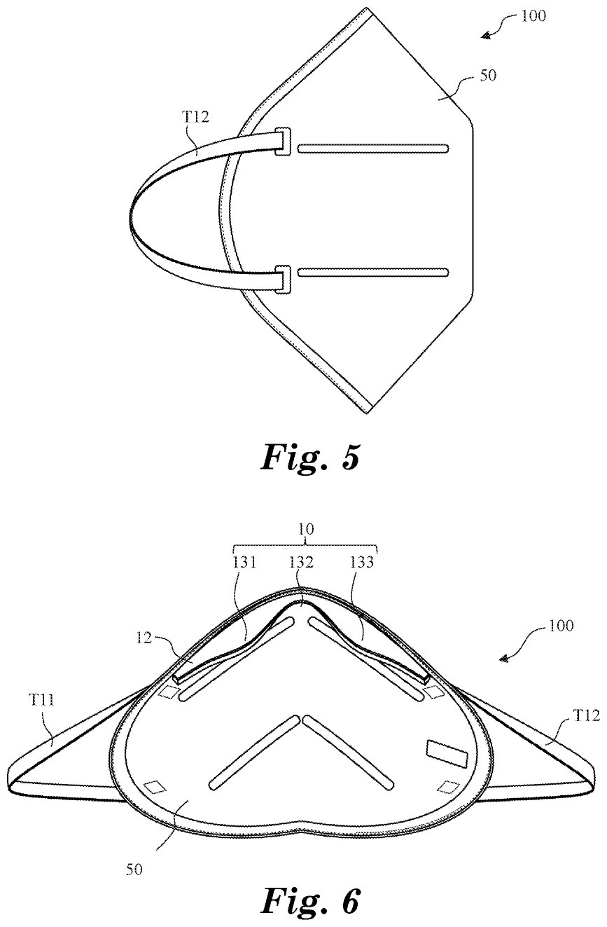

FIG. 5 is a side view of a first respirator 100 provided with the sealing strip 10, where an outer side of the first respirator 100 is shown. FIG. 6 is a perspective view of the first respirator 100, where a side (i.e., an inner side) of the first respirator 100 facing a wearer is shown. As shown in FIG. 5 and FIG. 6, the first respirator 100 is an earloop respirator. In the example shown in the drawing, the first respirator 100 is a foldable earloop mask. However, the present invention is not limited thereto, and in other examples, the sealing strip 10 may also be applied to non-foldable earloop masks or other respirators. In the manufacturing process of the first respirator 100, the sealing strip 10 according to the first embodiment of the present invention is attached to an inner side of a respirator main body 50 of the first respirator 100, and the air-proof layer 12 is located on an upper side. When the first respirator 100 is worn, a first lanyard T11 and a second lanyard T12 of the first respirator 100 are hung on the left and right ears of the wearer, respectively. The first respirator 100 is adjusted so that the nose of the wearer is accommodated in the concave part 132 of the sealing strip 10, and the first side surface 13 of the sealing strip 10 can conform to the contour of the face of the wearer to closely fit the periphery of the nose of the wearer, thus reducing or even eliminating the gap between the respirator and the nose of the wearer. By providing the above air-proof layer 12, the sealing performance between the first respirator 100 and the periphery of the nose of the wearer can be significantly improved. Therefore, good sealing between the first respirator 100 and the face of the wearer can be achieved without the need of generating an excessively large pressure between the first respirator 100 and the face of the wearer. Moreover, the material of the first sealing strip 10 is often softer than that of the respirator main body 50 of the first respirator 100. Therefore, during the process of adjusting the first respirator 100 to fit the contour of the face of the wearer, the sealing strip 10 may have a large deformation. On the one hand, the first respirator 100 can be adapted to wearers with different face contours. On the other hand, the deformation of the sealing strip 10 may cushion the force acting on the face of the wearer, thereby reducing the discomfort to the wearer. In addition, the sealing strip 10 with the air-proof layer 12 is provided on the inner side of the first respirator 100, and therefore the exhaled breath of the wearer will not be discharged upwards from between the first respirator 100 and the nose of the wearer, so that the situation of steaming up the glasses of the wearer can be completely alleviated or even avoided.

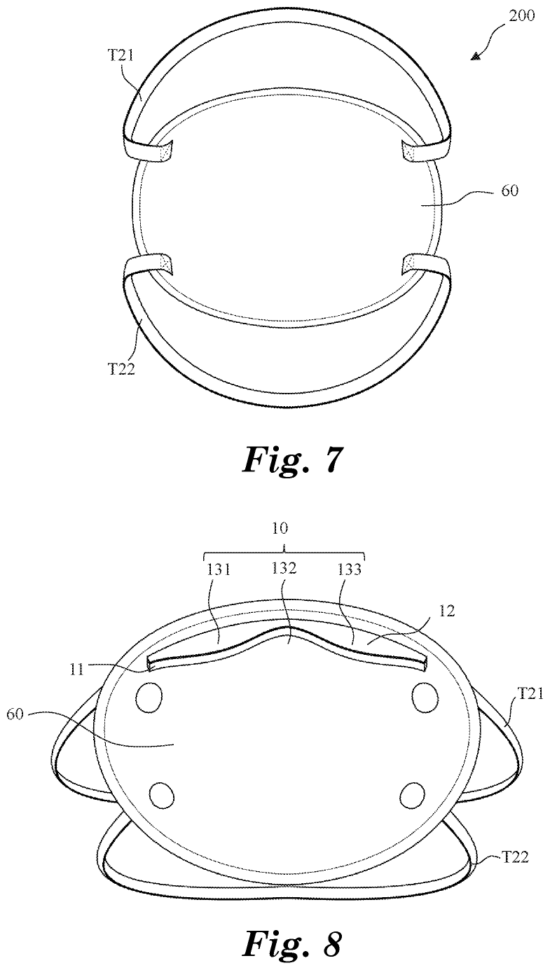

FIG. 7 is a front view of a second respirator 200 provided with the sealing strip 10, where an outer side of the second respirator 200 is shown. FIG. 8 is a perspective view of the second respirator 200, where a side (i.e., an inner side) of the second respirator 200 facing the wearer is shown. As shown in FIG. 7 and FIG. 8, the second respirator 200 is a head-mounted respirator. In the example in the drawing, the second respirator 200 is a non-foldable cup-shaped head-mounted mask. However, the present invention is not limited thereto, and the sealing strip 10 may also be applied to foldable head-mounted masks or other respirators. In the process of manufacturing the second respirator 200, the sealing strip 10 according to the first embodiment of the present invention is attached to an inner side of a respirator main body 60 of the second respirator 200, and the air-proof layer 12 is located on an upper side. When the second respirator 200 is worn, the head of the wearer passes through a first lanyard T21 and a second lanyard T22 of the second respirator 200 respectively, so as to hang the first lanyard T21 and the second lanyard T22 on the head or neck of the wearer. The second respirator 200 is adjusted so that the nose of the wearer is accommodated in the concave part 132 of the sealing strip 10, and the first side surface 13 of the sealing strip 10 can conform to the contour around the nose of the wearer to closely fit the periphery of the nose of the wearer, thus achieving good sealing between the second respirator 200 and the nose of the wearer. The second respirator 200 provided with the sealing strip 10 can achieve similar beneficial effects as the first respirator 100 described above.

The sealing strip 10 according to the first embodiment of the present invention and the method for manufacturing the same, as well as various respirators provided with the sealing strip 10 are described above. The sealing strip 10 according to the first embodiment of the present invention has the sinusoidal contour with a constant amplitude, and is provided with the air-proof layer 12, which can simplify the manufacturing of the sealing strip, fulfill the full use of materials, and improve the flexibility of the material selection of the sealing strip. Moreover, the respirator provided with the sealing strip 10 can improve the sealing performance between the respirator and the face of the wearer without the need of applying a large force on the face of the wearer, thus avoiding discomfort to the wearer and improving the wearing comfort of the respirator.

A sealing strip 20 according to a second embodiment of the present invention will be described below with reference to the accompanying drawings. The sealing strip 20 according to the second embodiment of the present invention is substantially the same in material and preparation method as the sealing strip 10 according to the first embodiment of the present invention, and the difference only lies in the overall contour shape and overall size of the sealing strip 20. In the accompanying drawings and the following, the same parts as those in the sealing strip 10 are denoted by the same or similar reference numerals, and the description will not be repeated. Hereinafter, only the difference between the sealing strip 20 and the sealing strip 10 will be illustrated.

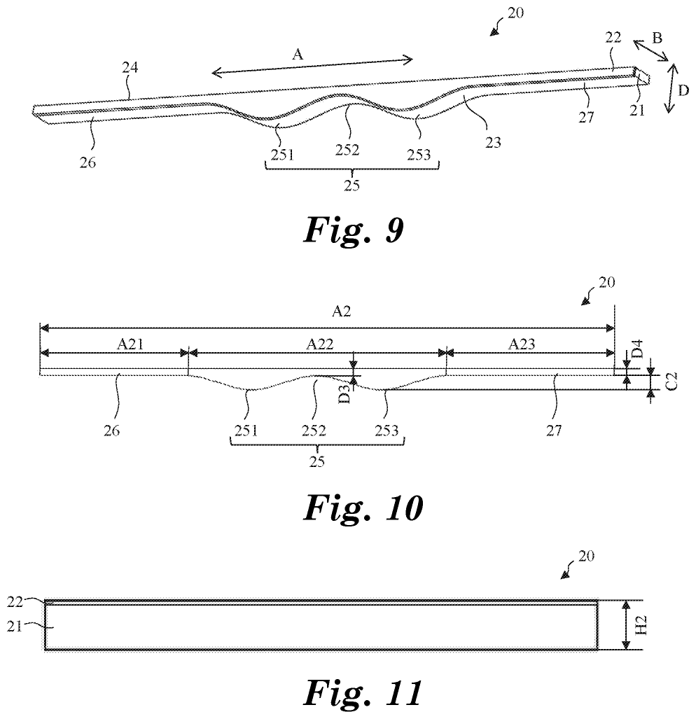

FIG. 9 is a perspective view of the sealing strip 20 according to the second embodiment of the present invention. FIG. 10 is a top view of the sealing strip 20. FIG. 11 is a side view of the sealing strip 20. It should be noted here that these accompanying drawings are not drawn in actual scale, but are only schematic.

The sealing strip 20 includes a main body part 21 and an air-proof layer 22 integrally formed in the height direction of the sealing strip 20, and the air-proof layer 22 is provided on an upper surface or a lower surface of the main body part 21 in the height direction. In FIG. 9, the air-proof layer 22 is provided on the upper surface of the main body part 21. The main body part 21 and the air-proof layer 22 of the sealing strip 20 may be made of the same materials as the main body part 11 and the air-proof layer 12 of the sealing strip 10. For example, the sealing strip 20 may be made by cutting, according to the contour of the sealing strip 20, the first material piece M provided with the air-proof layer S shown in FIG. 2; the portion of the first material piece M that is not provided with the air-proof layer S constitutes the main body part 21 of the sealing strip 20; the air-proof layer S provided on the first material piece M constitutes the air-proof layer 22 of the sealing strip 20.

The main body part 21 of the sealing strip 20 has a first side surface 23 extending in the lengthwise direction of the sealing strip 20 (the direction indicated by a double-headed arrow A in FIG. 9) and a second side surface 24 opposite to the first side surface 23. The first side surface 23 is a curved surface extending in the lengthwise direction of the sealing strip 20, and the second side surface 24 is a substantially flat surface. The main body part 21 has a curved surface part 25, and the curved surface part 25 includes a first convex part 251 and a second convex part 253 that are integrally formed. The first convex part 251 and the second convex part 253 are connected to each other in the lengthwise direction of the sealing strip 20, and define a concave part 252 located between the first convex part 251 and the second convex part 253. The first convex part 251 and the second convex part 253 are symmetrical about the concave part 252; the smallest thickness part of the curved surface part 25 at the concave part 132 is located at an intermediate position in the lengthwise direction of the curved surface part 25; a first side surface of the curved surface part 25 (i.e., the part of the first side surface 23 at the curved surface part 25) is a curved surface having a sinusoidal contour with a constant amplitude in the lengthwise direction of the sealing strip 20. Preferably, the length A22 of the curved surface part 25 may be set in a range of 90 mm to 130 mm. Preferably, the smallest thickness D3 of the curved surface part 25 at the concave part 232 (the smallest distance between the first side surface 23 and the second side surface 24 of the curved surface part 25) may be set in a range of 1 mm to 6 mm. More preferably, the smallest thickness D1 may be set in a range of 2 mm to 5 mm. Particularly preferably, the smallest thickness D3 of the curved surface part 25 at the concave part 232 is equal to the smallest thickness D4 of the curved surface part 25 at two ends in the lengthwise direction. Preferably, the greatest distance C2 by which the first convex part 251 and the second convex part 252 protrude from the smallest thickness position of the concave part 252 is set in a range of 4 mm to 10 mm. Preferably, the height H2 of the curved surface part 25 (that is, the distance between the upper surface and the lower surface of the curved surface part 25 in the direction indicated by an arrow B in FIG. 9) is in a range of 6 mm to 14 mm. The curved surface part 25 of the sealing strip 20 may have the same structure as the sealing strip 10. That is, the first convex part 251, the concave part 252, and the second convex part 253 of the curved surface part 25 may have the same contour and size as the first convex part 131, the concave part 132, and the second convex part 133 of the sealing strip 10 according to the first embodiment of the present invention.

In addition, as shown in FIG. 9 and FIG. 10, the sealing strip 20 further includes a first extension part 26 and a second extension part 27 located on two sides of the curved surface part 25 in the lengthwise direction of the sealing strip 20. The first extension part 26 extends from the first convex part 251 of the curved surface part 25 to a first end of the sealing strip 20 (the left end in FIG. 9 and FIG. 10), and the second extension part 27 extends from the second convex part 253 to a second end of the sealing strip 20 (the right end in FIG. 9 and FIG. 10). In the examples shown in FIG. 9 to FIG. 11, the heights of the first extension part 26 and the second extension part 27 between the upper surface and the lower surface are the same as the height of the curved surface part 25; the first extension part 26 and the second extension part 27 both have a constant thickness, and the thickness thereof is the same as the smallest thickness D3 of the curved surface part 25 at the concave part 232. However, the present invention is not limited thereto, and in other examples according to the present invention, the heights of the first extension part 26 and the second extension part 27 may be different from the height of the curved surface part 25, and the first extension part 26 and/or the second extension part 27 may have a variable thickness. In the examples shown in FIG. 9 to FIG. 11, the first extension part 26, the curved surface part 25, and the second extension part 27 are cut out integrally, and the length A21 of the first extension part 26 is the same as the length A23 of the second extension part 27. However, the present invention is not limited thereto. In other examples according to the present invention, the length A21 of the first extension part 26 and the length A23 of the second extension part 27 may be different, and/or the first extension part 26, the curved surface part 25, and the second extension parts 27 may be cut out separately and then connected to each other.

In an example where the first extension part 26, the curved surface part 25, and the second extension part 27 are cut out separately, for example, for the first material piece M provided with the air-proof layer S as shown in FIG. 2, the first material piece M may be cut along the first cutting line L1, the second cutting line L2, and the third cutting line L3 shown in FIG. 2 to obtain the first strip M1 and the second strip M2, and various curved surface segments are cut out from the first strip M1 and the second strip M2 to obtain a plurality of curved surface parts 25. In addition, one or a plurality of first extension parts 26 and one or a plurality of second extension parts 27 are cut out from the first material piece M. For example, the first material piece M is cut along two straight cutting lines (not shown) according to the thickness of the first extension part 26 and the second extension part 27 to form a third strip (not shown), and the third strip is cut into a plurality of sections corresponding to the first extension part 26 and the second extension part 27 respectively according to the length A21 of the first extension part 26 and the length A23 of the second extension part 27, thereby obtaining a plurality of first extension parts 26 and a plurality of second extension parts 27. Then, before or after the sealing strip 20 is attached to the respirator, the first extension part 26, the curved surface part 25, and the second extension part 27 that are obtained by cutting are connected to each other to form the sealing strip 20. In this example in which the first extension part 26, the curved surface part 25, and the second extension part 27 are cut out separately, the first strip M1 and the second strip M2 that are obtained by cutting are complementary in shape, and the third strip may be cut into a regularly-shaped cuboid strip in the lengthwise direction or widthwise direction of the first material piece M, thus reducing the waste material generated in the cutting process; therefore, the maximum utilization rate of the first material piece M can also be achieved.

In this example, since the curved surface part 25 of the sealing strip 20 has the same contour and size as the sealing strip 10, the curved surface part 25 of the sealing strip may be formed by using the method for forming the sealing strip 10. However, the present invention is not limited thereto. In the case where the amplitude and/or period of the curved surface contour of the curved surface part 25 of the sealing strip 20 is different from that of the sealing strip 10, the curved surface part 25 can still be formed by using a method similar to the above as long as the curve (for example, the amplitude and period of the sinusoidal curve) of the second cutting line L2 in FIG. 2 is configured to be the same as the contour of the curved surface part 25 of the sealing strip 20 in the lengthwise direction of the sealing strip.

The sealing strip 20 according to the second embodiment can achieve the same beneficial effects as the sealing strip 10 according to the first embodiment of the present invention.

In addition, compared with the sealing strip 10, the sealing strip 20 is also provided with the first extension part 26 and the second extension part 27 located on two sides of the curved surface part 25. The sealing strip 20 according to the second embodiment of the present invention may be used as a face sealing strip of various respirators, and may be configured to cover at least a part of a peripheral edge of the respirator in contact with the face of the wearer. When the sealing strip 20 is attached to the respirator, the first side surface 23 faces the face of the wearer, and the second side surface 24 is attached to the respirator main body of the respirator. Compared with the sealing strip 10, the sealing strip can cover a wider range of the peripheral edge of the respirator, and thus can provide a greater range of sealing between the respirator and the face of the wearer and improve the wearing comfort.

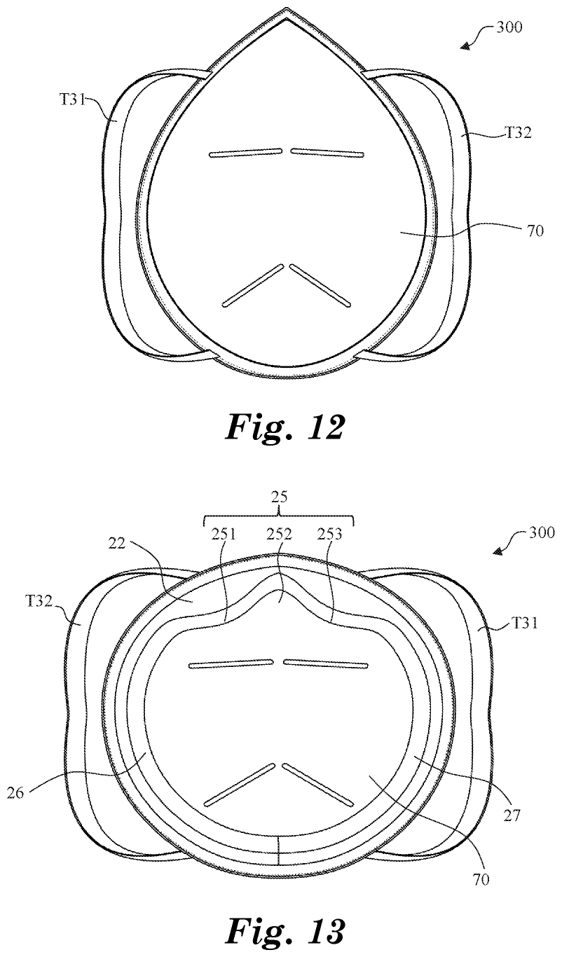

FIG. 12 and FIG. 13 show a third respirator 300 provided with the sealing strip 20 according to the second embodiment of the present invention, where an outer side and an inner side of the third respirator 300 are shown, respectively. The third respirator 300 shown in FIG. 12 and FIG. 13 is an earloop respirator. However, the present invention is not limited thereto, and the sealing strip 20 according to the second embodiment of the present invention may also be applied to a head-mounted respirator. As shown in FIG. 13, the sealing strip 20 is provided on the inner side of the respirator main body 70 of the third respirator 300 to cover the entire peripheral edge of the third respirator 300 in contact with the face of the wearer, and the air-proof layer 22 is provided at the peripheral side, that is, toward the upper side in the nose area, and toward the outer side in the cheek area. When the third respirator 300 is worn, a first lanyard T31 and a second lanyard T32 are respectively hung on the left and right ears of the wearer, and the third respirator 300 is adjusted so that the curved surface part 25 of the sealing strip 20 conforms to the contour around the nose of the wearer, and the first extension part 26 and the second extension part 27 conform to the contours of the left and right cheeks of the wearer, respectively. By providing the sealing strip 20 with the above air-proof layer 22, the peripheral edge of the third respirator 300 can be closely fitted to the face of the wearer without the need of applying a large pressure on the face of the wearer, thus reducing the wearing discomfort and avoiding obvious indentation or even trauma on the face of the wearer, which can significantly improve the wearing comfort.

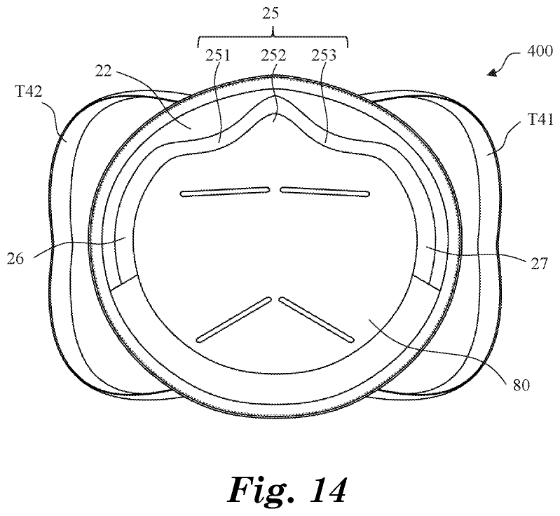

FIG. 14 shows a fourth respirator 400 provided with the sealing strip 20 according to the second embodiment of the present invention. The fourth respirator 400 is substantially the same as the third respirator 300 except that the sealing strip 20 covers only a part of a peripheral edge of the fourth respirator 400 in contact with the face of a wearer, as shown in FIG. 14. The fourth respirator 400 can produce substantially the same beneficial effects as the third respirator 300 described above.

The sealing strip according to the preferred embodiment of the present invention, various respirators provided with the sealing strip according to the present invention, and the method for manufacturing the sealing strip have been described above with reference to the accompanying drawings. The sealing strip, the respirator provided with the sealing strip, and the method for manufacturing the sealing strip according to the present invention can simplify the manufacturing of the sealing strip, improve the material utilization rate, improve the sealing performance between the respirator and the face of the wearer, and alleviate or avoid indentation or trauma on the face of the wearer, thus improving the wearing comfort of the respirator.

In the above example, the second cutting line L2 is a sinusoidal curve with a constant amplitude, and the plurality of curved surface segments of the first strip M1 and the second strip M2 obtained by cutting the first material piece M have the same contour. However, the present invention is not limited thereto. In other embodiments according to the present invention, the second cutting line L2 may also be configured to be a sinusoidal curve with a variable amplitude, and the first strip and the second strip obtained by cutting the first material piece M1 may each include a plurality of curved surface segments with different contours. The plurality of curved surface segments with different contours may be used as curved surface parts of sealing strips in different sizes. Therefore, curved surface parts of sealing strips of various types can be cut out in one cut, and the maximum utilization rate of the material can still be achieved.

In the above embodiment, the application of the sealing strip according to the present invention in a respirator is shown by using the respirator as the target product. However, it should be understood that the sealing strip according to the present invention may also be applied to target products other than respirators.

Here, the exemplary embodiments of the present invention have been described in detail, but it should be understood that the present invention is not limited to the specific embodiments described and illustrated in detail above. Those skilled in the art can make various variations and variants of the present invention without departing from the gist and scope of the present invention. All these variations and variants fall within the scope of the present invention. Moreover, all components described here can be replaced by other technically equivalent components.

1. A sealing strip for a respirator, the sealing strip comprising:
a main body part, the main body part having an upper surface, a lower surface, a first side surface, and a second side surface opposite to the first side surface, wherein
the second side surface is to be attached to a respirator main body of the respirator so that the first side surface faces a wearer, and the sealing strip covers at least a part of a peripheral edge of the respirator main body to be in contact with the face of the wearer, wherein
the main body part comprises a curved surface part; the curved surface part comprises a first convex part and a second convex part; the first convex part and the second convex part are connected to each other in the lengthwise direction of the sealing strip to define a concave part located between the first convex part and the second convex part; the concave part is configured to accommodate the nose of the wearer; the first convex part and the second convex part are symmetrical about the concave part, and a first side surface of the curved surface part is a sinusoidal curved surface with a constant amplitude extending in the lengthwise direction of the sealing strip.

2. The sealing strip for the respirator according to claim 1, wherein the distance between the first side surface and a second side surface of the curved surface part is the thickness of the curved surface part, and the smallest thickness of the curved surface part at two ends in the lengthwise direction of the sealing strip is equal to the smallest thickness of the curved surface part at the concave part.

3. The sealing strip for the respirator according to claim 1, wherein the main body part further comprises a first extension part and a second extension part respectively located on two sides of the curved surface part in the lengthwise direction of the sealing strip; the first extension part extends from the first convex part to a first end of the sealing strip; the second extension part extends from the second convex part to a second end of the sealing strip, wherein
the distance between a first side surface and a second side surface of the first extension part and/or the second extension part is constant or variable.

4. The sealing strip for the respirator according to claim 3, wherein the first extension part and the second extension part have the same contour.

5. The sealing strip for the respirator according to claim 3, wherein the first extension part, the curved surface part, and the second extension part are formed integrally, or
the first extension part, the curved surface part, and the second extension part are formed separately and attached to each other.

6. The sealing strip for the respirator according to claim 1, wherein the distance between an upper surface and a lower surface of the curved surface part is 6 mm to 14 mm, and/or
the length of the curved surface part in the lengthwise direction of the sealing strip is 90 mm to 130 mm, and/or
at the concave part, the smallest distance between the first side surface and the second side surface of the curved surface part is 1 mm to 6 mm, and/or
the greatest distance between a first side surface and a second side surface of the first convex part and the second convex part is greater than the smallest distance between the first side surface and the second side surface of the curved surface part by 4 mm to 10 mm.

7. The sealing strip for the respirator according to claim 1, wherein the sealing strip further comprises an air-proof layer and an anchor layer; the air-proof layer is anchored on one of the upper surface and the lower surface of the main body part through the anchor layer, and when the sealing strip is attached to the respirator, the air-proof layer of the sealing strip is located on a peripheral side.

8. A respirator, the respirator comprising a respirator main body, wherein the respirator further comprises the sealing strip for the respirator according to claim 1 and the sealing strip is attached to the respirator main body to cover at least a part of a peripheral edge of the respirator main body to be in contact with the face of a wearer.

9. A method for manufacturing a sealing strip, comprising:
providing a first material piece; and
cutting the first material piece to prepare a main body part of the sealing strip, the main body part having an upper surface, a lower surface, a first side surface, and a second side surface opposite to the first side surface, wherein the second side surface is to be attached to a respirator main body of a respirator so that the first side surface faces a wearer, and the sealing strip covers at least a part of a peripheral edge of the respirator main body to be in contact with the face of the wearer, wherein
the main body part is cut to have a curved surface part; the curved surface part comprises a first convex part and a second convex part; the first convex part and the second convex part are connected to each other in the lengthwise direction of the sealing strip to define a concave part located between the first convex part and the second convex part; the concave part is configured to accommodate the nose of the wearer; the first convex part and the second convex part are symmetrical about the concave part, and a first side surface of the curved surface part is a sinusoidal curved surface with a constant amplitude extending in the lengthwise direction of the sealing strip.

10. The method for manufacturing the sealing strip according to claim 9, wherein the step of cutting the first material piece comprises: cutting the first material piece along a first cutting line, a second cutting line, and a third cutting line respectively to form a first strip and a second strip fitted to each other along the second cutting line, wherein
the first cutting line and the third cutting line are straight lines parallel to each other; the second cutting line is located between the first cutting line and the third cutting line, and the second cutting line comprises one or a plurality of sinusoidal curve segments, so that the first strip and the second strip each comprise at least one curved surface segment having the same contour as the curved surface part, and
the step of cutting the first material piece further comprises cutting the first strip and the second strip to form the sealing strip comprising the curved surface part.

11. The method for manufacturing the sealing strip according to claim 10, wherein the distance between the first side surface and a second side surface of the curved surface part is the thickness of the curved surface part, and the smallest thickness of the curved surface part at two ends in the lengthwise direction of the sealing strip is equal to the smallest thickness of the curved surface part at the concave part.

12. The method for manufacturing the sealing strip according to claim 10, wherein the period of the one or plurality of sinusoidal curve segments is constant.

13. The method for manufacturing the sealing strip according to claim 10, wherein the second cutting line further comprises another line segment alternating with the sinusoidal curve segment.

14. The method for manufacturing the sealing strip according to claim 13, wherein the main body part further comprises a first extension part and a second extension part respectively located on two sides of the curved surface part in the lengthwise direction of the sealing strip, and the step of cutting the first material piece further comprises:
cutting the main body part out from the first strip and the second strip respectively, so that the first extension part, the curved surface part, and the second extension part are formed integrally.

15. The method for manufacturing the sealing strip according to claim 10, wherein the main body part further comprises a first extension part and a second extension part respectively located on two sides of the curved surface part in the lengthwise direction of the sealing strip, and the step of cutting the first material piece further comprises:
cutting the curved surface segment out from the first strip and the second strip to form the curved surface part of the main body part; and
cutting the first material piece to form one or a plurality of first extension parts and one or a plurality of second extension parts; and
the method for manufacturing the sealing strip further comprises: attaching the first extension part and the second extension part to the two sides of the curved surface part respectively before or after the curved surface part is attached to the respirator main body.

16. The method for manufacturing the sealing strip according claim 9, wherein the method for manufacturing the sealing strip further comprises: before cutting the first material piece, providing an air-proof layer and an anchor layer on the first material piece so that the sealing strip further comprises the air-proof layer anchored on one of the upper surface and the lower surface of the main body part through the anchor layer.

17. The method for manufacturing the sealing strip according to claim 16, wherein the air-proof layer is formed on the first material piece in one of the following manners:
attaching an incompletely cured air-proof film to one side surface of the first material piece and curing the same to form the air-proof layer and the anchor layer integrally with the first material piece; and
spraying an anchor layer material on one side surface of the first material piece and/or one side surface of an air-proof member, and fitting the air-proof member to the first material piece through the anchor layer material, wherein the anchor layer material is cured to form the anchor layer, and the air-proof member is anchored on the first material piece through the anchor layer to form the air-proof layer.

18. A sealing strip, wherein the sealing strip is manufactured by using the method for manufacturing the sealing strip according to claim 9.

19. A respirator, the respirator comprising a respirator main body, wherein the respirator further comprises the sealing strip according to claim 18.
